(19) United States
(12) Patent Application Publication
(10) Pub. No.: US 2012/0248377 A1
(43) Pub. Date: Oct. 4, 2012

(54) Catalytic Reactor Including a Catalytic Cellular Structure and at least One Structural Element

(75) Inventors: Pascal Del-Gallo, Dourdan (FR); Daniel Gary, Montigny Le Bretonneux (FR); Aude Cuni, Frankfurt (DE); Mathieu Cornillac, St. Gilles les Bains (FR)

(73) Assignee: L'Air Liquide Societe Anonyme Pour L'Etude Et L' Exploitation Des Procedes Georges Claude, Paris (FR)

(21) Appl. No.: 13/513,364

(22) PCT Filed: Nov. 24, 2010
(86) PCT No.: PCT/FR10/52501

§ 371 Date: Jun. 1, 2012

(30) Foreign Application Priority Data
Dec. 1, 2009 (FR) 0958553

(51) Int. Cl. B01J 7/00; C01B 3/38

(52) U.S. Cl. 252/373; 422/211

(57) ABSTRACT

The invention relates to a catalytic reactor including at least two catalytic cellular architectures and at least one structural element, inserted between the two catalytic cellular architectures, in which the entire outer perimeter is in contact with the inner wall of the reactor, the cellular architecture and the structural element being arranged coaxially.

The subject of the present invention is a catalytic reactor comprising a catalytic cellular structure, in particular a catalytic ceramic or metallic foam, and at least one structural element that reduces the preferential flows of the gas along the walls of the reactor and that promotes heat transfer.

Foams made of ceramic or even of metal alloy are known to be used as catalyst support in chemical reactions, in particular heterogeneous catalysis reactions. These foams are particularly beneficial for highly exothermic or endothermic reactions (e.g. the exothermic Fischer-Tropsch reaction, the water-gas shift reaction, partial oxidation reaction, methanation reaction, etc.), and/or for catalytic reactors where high space velocities are sought (steam reforming of natural gas, naphtha, LPG, etc.).

The most widespread method used to create ceramic foams with open macroporosity consists of impregnating a polymer foam (usually a polyurethane or a polyester foam), cut to the desired geometry, with a suspension of ceramic particles in an aqueous or organic solvent. The excess suspension is removed from the polymer foam by repeated application of a compression or by centrifugal spinning, so as to leave only a fine layer of suspension on the strands of the polymer. After one or more impregnations of the polymer foam using this method, the foam is dried to remove the solvent while maintaining the mechanical integrity of the deposited layer of ceramic powder. The foam is then heated to a high temperature in two stages. The first stage known as the binder removal stage consists in degrading the polymer and any other organic compounds that might be present in the suspension, through a slow and controlled increase in temperature until the volatile organic compounds have been completely eliminated (typically 500-900° C.). The second stage known as sintering consists in consolidating the residual inorganic structure using a high-temperature heat treatment.

This method of manufacture thus makes it possible to obtain an inorganic foam which is the replica of the initial polymer foam, give or take the shrinkage caused by the sintering. The final porosity achievable through this method covers a range from 30% to 95% for a pore size ranging from 0.2 mm to 5 mm. The final pore size (or open macroporosity) is derived from the macrostructure of the initial organic “template” (polymer foam, generally polyurethane foam). Said macrostructure generally varies from 60 to 5 ppi (ppi stands for pores per inch, the pores measuring from 50 μm to 5 mm).

The foam may also be of a metallic nature with a chemical formulation that allows the architecture to have chemical stability under operating conditions (temperature, pressure, gas composition, etc.). In the context of an application to the steam reforming of natural gas, the metallic cellular architecture will consist of chemical formulations based on NiFeCrAl oxidized at the surface, this surface oxidation making it possible to create a micron-scale layer of alumina that protects the metallic alloy from any corrosion phenomena.

Cellular architectures that are ceramic and/or metallic covered with ceramic are good supports for catalysts in numerous respects:
they have a maximum surface area/volume (m²/m³) ratio, so as to increase the geometric area for exchange and therefore indirectly increase the catalytic efficiency,
they minimize pressure drops along the bed (between the inlet and the outlet of the catalytic reactor),
they have heat transfer of improved axial and/or radial efficiency. Axial means along the axis of the catalytic reactor, and radial means from the internal or external wall of the catalytic reactor toward the center of the catalytic bed,
they improve the thermomechanical and/or thermochemical stresses withstood by the bed,
they improve the fill density of a tube by comparison with a random filling brought about by conventional structures (spheres, pellets, cylinders, barrels, etc.),
control of the filling makes it possible to ensure homogeneity of the filling from one tube to another.

The choice of the structure suitable for a given reaction is often the result of a compromise between optimizing these various factors and the associated architecture(s)/microstructure(s) of the catalyst(s).

Furthermore, in the case of a reactor made up of several tubes in parallel, one other series of problems is that of the homogeneity of the filling of the tubes. Specifically, optimized operation of the process requires that the various tubes behave in similar ways, particularly in terms of pressure drops and the minimizing of hot spots. This involves rigorous quality control of the filling of the tubes.

The overall structuring of a fixed-bed catalytic reactor is a multilevel “phenomenon”:
The microstructure of the material (catalyst) itself, namely its chemical formulation, the microporosity and/or mesoporosity, the size, dispersion and metallic surface of the active phase(s), the thickness of the deposit(s), etc.
The architecture of the catalyst, that is to say its geometric form (granules, barrels, honeycomb monoliths, cellular structures of the foam type, spheres, pills, sticks, etc.),
The structure of the bed within the reactor (stack of catalytic materials), that is to say the layout of the catalytic materials of controlled architecture/microstructure within the catalytic reactor. For example, successive stacks which may or may not include non-catalytic elements of varying functionalities may be envisaged by way of catalytic bed structure.

One of the disadvantages of the monolithic structures of catalytic reactors lies in the difference in expansion between these structures and the tubes (reaction chamber) containing them; this is liable to lead to insufficient contact between certain architectures (monoliths, etc.) and the inner wall of the tube. This physical non-continuity leads to:
preferential flows of the gas along the walls (by-pass effect),
a lack of conductive heat transfer between the tube and the region of the catalytic bed concerned.

What is meant by the structure of catalytic reactors is the successive stacks of diverse and varied architectures (foams, barrels, spheres, etc.) of ceramic nature and/or of metallic nature covered with ceramic and of controlled microstructures.

What is meant by the monolithic structure of the catalytic reactors is the successive stacks of cellular architectures (foams) made of ceramic and/or of metal covered with ceramic and of controlled microstructures.

A solution of the present invention is a catalytic reactor comprising:

at least two catalytic cellular architectures, and

at least one structural element, inserted between the two catalytic cellular architectures, and the whole of the external perimeter of which is in contact with the inner wall of the reactor; the cellular architecture and the structural element being arranged coaxially.

Depending on the case, the reactor according to the invention may have one or more of the following features:
the catalytic cellular architecture is a catalytic ceramic foam;
the catalytic cellular architecture is a metallic foam covered with a protective oxide layer onto which a catalyst is deposited;
the catalytic reactor comprises a structural element in the form of a ring, half rings, disk or pierced grid, or at least two structural elements in the form of a ring, disk or pierced grid, or exhibiting a combination of these forms;
the structural element is a disk having at least one opening, for example with 4 openings, with the opening(s) representing between 85% and 95% of the surface area of the disk; (FIG. 5)
the structural element is of metallic nature; it preferably comprises an alloy rich in nickel and in chromium;
the metallic structural element is machined from the same alloy as the shell of the catalytic reactor. For reactions taking place at temperatures of the order of 800-950° C., as in the case of the steam reforming reaction, the shell of the catalytic reactor in general consists of an alloy comprising nickel and chromium;
   the structural element is of ceramic nature.

The catalytic cellular architectures are manufactured from a matrix made of a polymer material chosen from polyurethane (PU), poly(vinyl chloride) (PVC), polystyrene (PS), cellulose and latex but the ideal choice of the foam is limited by strict requirements.

The polymer material must not release toxic compounds; for example, PVC is avoided as it may result in the release of hydrogen chloride.

The catalytic cellular architecture, when it is of ceramic nature, typically comprises inorganic particles, chosen from alumina (Al₂O₃) and/or doped alumina (La (1 to 20% by weight)—Al₂O₃, Ce (1 to 20% by weight)—Al₂O₃, Zr (1 to 20% by weight)—Al₂O₃), magnesia (MgO), spinel (MgAl₂O₄), hydrotalcites, CaO, silicocalcareous products, silicoaluminous products, zinc oxide, cordierite, mullite, aluminum titanate and zircon (ZrSiO₄); or ceramic particles, chosen from ceria (CeO₂), zirconium (ZrO₂), stabilized ceria (Gd₂O₃ between 3 and 10 mol % in ceria) and stabilized zirconium (Y₂O₃ between 3 and 10 mol % in zirconium) and mixed oxides of formula (I):

Ce(₁₋ₓ)ZrₓO(_{2-δ}) (I),

where 0<x<1 and 6 ensures the electrical neutrality of the oxide, or doped mixed oxides of formula (II):

Ce(_{1-x-y})ZrₓD_{y}O_{2-δ} (II),

where D is chosen from magnesium (Mg), yttrium (Y), strontium (Sr), lanthanum (La), praseodymium (Pr), samarium (Sm), gadolinium (Gd), erbium (Er) or ytterbium (Yb); where 0<x<1, 0<y<0.5 and 6 ensures the electrical neutrality of the oxide.

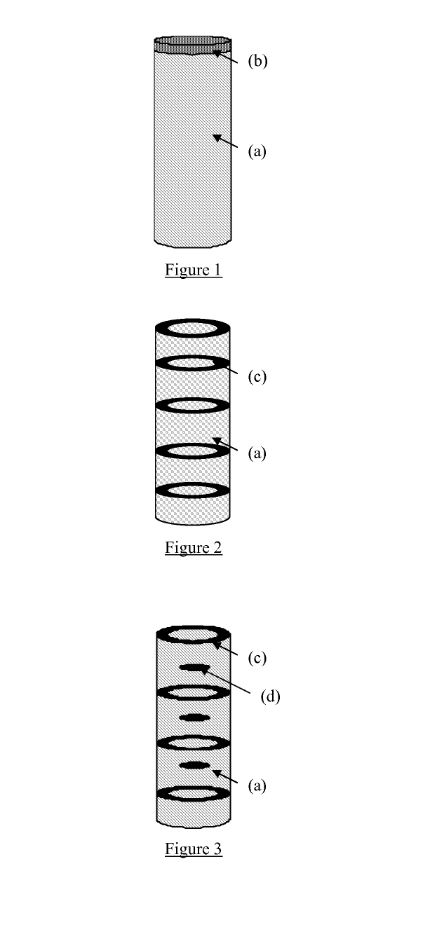

### The invention will be described in greater detail with the aid of FIGS. 1 to 5. Each figure represents an example of a structural element. FIG. 1 represents:

one/some ceramic and/or metallic cellular architecture(s) (a) having controlled catalytic microstructures, and
a static mixer (b), in particular that is metallic.

In this reactor, the bed is entirely structured of ceramic foam, in order to benefit from a catalytic activity concentration and optimal heat transfers along the whole tube. The static mixer at the inlet makes it possible to prevent possible preferential flows at the walls. The static mixer is in contact with the inner wall of the reactor. The foam may also be of metallic nature.

FIG. 2 represents:
ceramic and/or metallic cellular architectures (a) having controlled catalytic microstructures (these architectures are, for example, stacked blocks of catalytic ceramic foam), and
non-catalytic structural elements, preferably that are metallic or ceramic, in the form of rings (c) between the cellular architectures. In the context of structural elements of ceramic nature, inorganic materials of non-oxide type having intrinsic high thermal conductivity properties (silicon carbide, silicon nitride, etc.) will be chosen.

In this reactor, the possible flows at the walls are prevented by the rings. The rings are in contact with the inner wall of the reactor.

FIG. 3 represents:
ceramic and/or metallic cellular architectures (a) having controlled catalytic microstructures (these architectures are, for example, stacked blocks of catalytic ceramic foam), and
non-catalytic structural elements, preferably that are metallic, in the form of rings (c) and of central disks (d) positioned between the cellular architectures.

In this reactor, the possible flows at the walls are prevented by the rings. Moreover, flow disturbance is observed due to the central disks positioned between two cellular architectures in order to increase convection. The disks are not in contact with the inner wall of the reaction chamber, whereas the rings are in contact with this same inner wall.

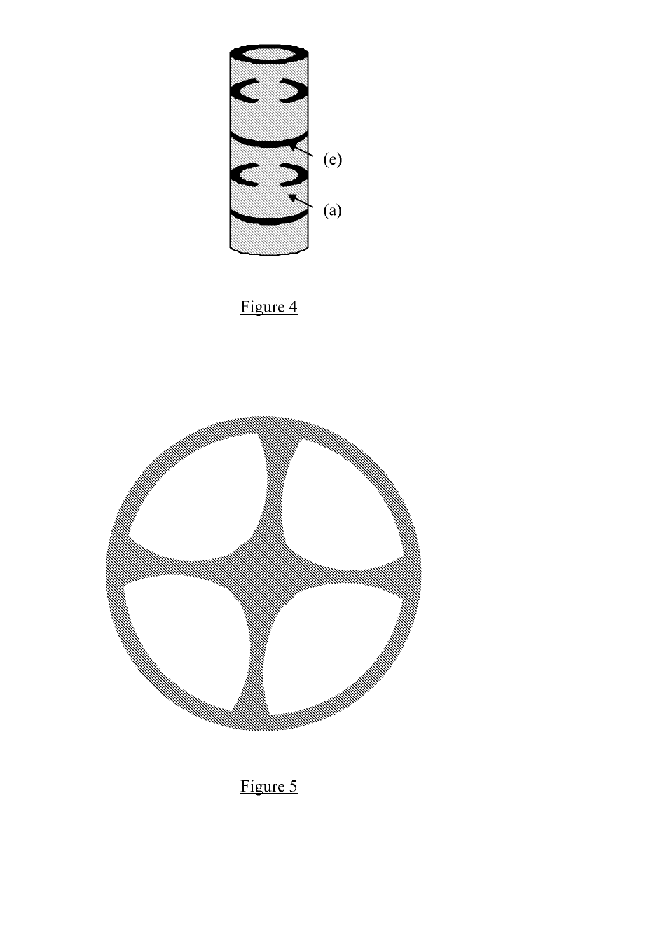

FIG. 4 represents:
ceramic and/or metallic cellular architectures (a) having controlled catalytic microstructures (these architectures are, for example, stacked blocks of catalytic ceramic foam), and
non-catalytic structural elements, preferably that are metallic or ceramic, in the form of half rings (e) positioned between the cellular architectures.

In this reactor, the possible flows at the walls are prevented by the half rings. The half rings are in contact with the inner wall of the reactor.

FIG. 5 represents an example of a structural element to be inserted between the cellular architectures. This element has the shape of a ring having a diameter corresponding to the inner diameter of the reaction chamber, with a cross whose center is the middle of the diameter of the cellular architecture.

This element, if it is metallic, must be highly open in order to generate the smallest possible pressure drop and will preferably be machined from the same alloy as the reactor so that the expansion is identical to that of the reaction chamber so as to stick well to the wall.

The structural element according to FIG. 5 is in contact with the inner wall of the reactor. This element inserted between the cellular architectures makes it possible to:
prevent flows along the walls,
drive heat, by conduction via the arms of the cross, toward the core of the reactor (center of the cross), and
disturb the flow of the fluid by means of the center of the cross, which improves convection.

The catalytic reactor according to the invention may be used to produce gaseous products, in particular a syngas.

The feed gas preferably comprises oxygen, carbon dioxide or steam mixed with methane. However, these catalytic bed structures can be deployed in all catalytic reactors used in the method of producing hydrogen by steam reforming, namely, in particular, pre-reforming beds, reforming beds and water-gas shift beds.

The reaction temperatures that are used are high and are between 200 and 1000° C., preferably between 400 and 1000° C.

The pressure of the reactants (CO, H₂, CH₄, H₂O, CO₂, etc.) may be between 10 and 50 bar, preferably between 15 and 35 bar.

1-11. (canceled)

12. A catalytic reactor comprising at least two catalytic cellular architectures and at least one structural element, inserted between the two catalytic cellular architectures, wherein:
an entirety of an external perimeter of the combined catalytic cellular architectures and structural element(s) is in contact with an inner wall of the reactor; and
the cellular architectures and the structural element(s) are arranged coaxially.

13. The catalytic reactor of claim 12, wherein said at least one structural element is placed at an upper end of the catalytic architectures.

14. The catalytic reactor of claim 12, wherein the catalytic cellular architecture is a catalytic ceramic foam.

15. The catalytic reactor of claim 12, wherein the catalytic cellular architecture is a metallic foam covered with a protective oxide layer onto which a catalyst is deposited.

16. The catalytic reactor of claim 12, wherein the structural element is shaped as at least one ring, at least one half ring, at least one disk, at least one pierced grid; or a combinations of two or more thereof.

17. The catalytic reactor of claim 12, wherein the structural element is shaped as a disk having at least one opening, the opening(s) representing between 85% and 95% of a surface area of the disk.

18. The catalytic reactor of claim 12, wherein the structural element is metallic.

19. The catalytic reactor of claim 18, wherein the metallic structural element is machined from a same alloy as a shell of the catalytic reactor.

20. The catalytic reactor of claim 12, wherein the structural element is ceramic.

21. A method of producing syngas, comprising the step of producing syngas from a feed gas comprising oxygen and/or carbon dioxide and/or steam mixed with methane, wherein:
the reactor of claim 12 is used as a pre-reforming bed, a reforming bed and/or a water-gas shift bed;
the reactor is maintained at a reaction temperature of between 200 and 1000° C., preferably between 400 and 1000° C.; and
a pressure of gaseous reactants fed to the reactor or gaseous products produced by the reactor of claim 12 are at a pressure of between 10 and 50 bar.

22. The method of claim 21, wherein the pressure of the gaseous reactants fed to the reactor of claim 12 or gaseous products produced by the reactor of claim 12 are at a pressure of between 15 and 35 bar.
